(19) United States
(12) Patent Application Publication
(10) Pub. No.: US 2025/0327782 A1
(43) Pub. Date: Oct. 23, 2025

(54) Data Processing Method, Chromatograph Mass Spectrometer, and Computer Readable Medium Having Program Stored Thereon In Non-Transitory Manner

(71) Applicant: SHIMADZU CORPORATION, Kyoto-shi (JP)

(72) Inventor: Akira NODA, Kyoto-shi (JP)

(73) Assignee: SHIMADZU CORPORATION, Kyoto-shi (JP)

(21) Appl. No.: 19/184,299

(22) Filed: Apr. 21, 2025

(30) Foreign Application Priority Data
Apr. 22, 2024 (JP) 2024-069261

(51) Int. Cl. G01N 30/86; G01N 30/02; G01N 30/72; G01N 30/88; H01J 49/00

(52) U.S. Cl. CPC G01N 30/8624; G01N 30/7233; G01N 30/88; H01J 49/004; G01N 2030/027; G01N 2030/8813

(57) ABSTRACT

A data processing method includes: obtaining a feature amount of a target component and a measurement value of the target component from a first chromatogram, the first chromatogram being obtained by analyzing a target sample; obtaining feature amounts and measurement values of reference components from second and third chromatograms, the second and third chromatograms being obtained by analyzing a standard sample; and correcting the measurement value of the target component based on the feature amount of the target component, the feature amounts of the reference components and the measurement values of the reference components.

### CROSS REFERENCE TO RELATED APPLICATIONS

This nonprovisional application is based on Japanese Patent Application No. 2024-069261 filed on Apr. 22, 2024 with the Japan Patent Office, the entire contents of which are hereby incorporated by reference.

### BACKGROUND OF THE INVENTION

### Field of the Invention

The present disclosure relates to a data processing method, an information processing device, a chromatograph mass spectrometer, and a program, and more particularly to data processing for correcting measurement values obtained by an analysis device.

### Description of the Background Art

Measurement values obtained by an analysis device may be affected by not only an analysis condition but also a state of the analysis device during analysis. For example, in a chromatograph mass spectrometer, contamination of a mass spectrometry unit may affect the measurement sensitivity. Therefore, even when the same sample is measured under the same analysis condition, different measurement values may be obtained before and after cleaning of the mass spectrometry unit. That is, the measurement values obtained by the analysis device include an error caused by a difference in timing of analysis.

As a method of correcting the error, “Procedures for large-scale metabolic profiling of serum and plasma using gas chromatography and liquid chromatography coupled to mass spectrometry” by Dunn, Warwick B., et al., Nature protocols 6.7 (2011): 1060-1083 discloses the technique for correcting measurement values of samples based on measurement values of a pooled QC prepared by mixing all of the samples in equal amounts. In “Procedures for large-scale metabolic profiling of serum and plasma using gas chromatography and liquid chromatography coupled to mass spectrometry” by Dunn, Warwick B., et al., Nature protocols 6.7 (2011); 1060-1083, the pooled QC is analyzed in between analyses of the samples. After the analysis, LOESS smoothing is performed using only the measurement values of the pooled QC, to calculate an approximate curve. Based on the calculated approximate curve, the measurement values of the samples are corrected. This method is called “QC-based robust LOESS signal correction (QC-RLSC) method”. The pooled QC is one type of standard sample.

The pooled QC is prepared by mixing all of the samples in equal amounts. Since all of the samples are mixed in equal amounts, an amount of each component included in the pooled QC is an average of all of the samples about the amount of each component. The measurement values of the pooled QC are close to an average value of the measurement values of the samples, which makes it possible to prevent the measurement values of the pooled QC from significantly deviating from the measurement values of the samples. In addition, since the pooled QC is prepared by mixing all of the samples, a component included in at least one of the samples is included in the pooled QC. Therefore, even when a component to be subjected to correction is unknown at the start of measurement, measurement values of the component can be subjected to correction processing after measurement.

### SUMMARY OF THE INVENTION

When a standard sample is prepared in advance and measurement values of samples are corrected based on measurement values obtained by analyzing the standard sample as in the method disclosed in “Procedures for large-scale metabolic profiling of serum and plasma using gas chromatography and liquid chromatography coupled to mass spectrometry” by Dunn, Warwick B., et al., Nature protocols 6.7 (2011): 1060-1083, a component to be subjected to correction needs to be included in the standard sample. However, when a sample to be measured is newly added after the standard sample is prepared, a component that is not included in the standard sample may be included in the sample. In order to correct measurement values of the component in such a case, a user needs to prepare a new standard sample including the component. Since the user needs to prepare the new standard sample, the measurement cost may increase.

The present disclosure has been made in view of the above-described circumstances and an object of the present disclosure is to correct a measurement value of a prescribed component in a target sample by using a result obtained by analyzing a standard sample, when correcting the measurement value of the prescribed component that is not included in the standard sample.

A data processing method according to a first aspect of the present disclosure is a data processing method of correcting a measurement value of a target component in a target sample by using a standard sample including a first reference component and a second reference component, the measurement value of the target component being obtained by an analysis device including a mass spectrometer or a chromatograph mass spectrometer. About the target component, the first reference component and the second reference component, a measurement value of each component is a value related to an amount of the corresponding component, and a feature amount of each component is a retention time and/or a mass-to-charge ratio of the corresponding component. The data processing method includes: (1) obtaining a feature amount of the target component and the measurement value of the target component from a first chromatogram, the first chromatogram being obtained by analyzing the target sample at a first timing under a first analysis condition; (2) obtaining a feature amount of the first reference component, a feature amount of the second reference component, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition; and (3) correcting the measurement value of the target component based on the feature amount of the target component, the feature amount of the first reference component, the feature amount of the second reference component, the measurement value of the first reference component at each timing, and the measurement value of the second reference component at each timing.

A chromatograph mass spectrometer according to a second aspect of the present disclosure includes: a chromatograph unit; a mass spectrometry unit; and a control unit. The chromatograph unit separates, over time, a target component included in a target sample and a first reference component and a second reference component included in a standard sample. The mass spectrometry unit measures an ion having a mass-to-charge ratio derived from the target component, the first reference component and the second reference component separated by the chromatograph unit. The control unit controls operations of the chromatograph unit and the mass spectrometry unit. The control unit is configured to obtain a feature amount of the target component and a measurement value of the target component from a first chromatogram, the first chromatogram being obtained by analyzing the target sample at a first timing under a first analysis condition. The control unit is configured to obtain a feature amount of the first reference component, a feature amount of the second reference component, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition. The control unit is configured to correct the measurement value of the target component based on the feature amount of the target component, the feature amount of the first reference component, the feature amount of the second reference component, the measurement value of the first reference component at each timing, and the measurement value of the second reference component at each timing. About the target component, the first reference component and the second reference component, a measurement value of each component is a value related to an amount of the corresponding component, and a feature amount of each component is a retention time and/or a mass-to-charge ratio of the corresponding component.

A computer readable medium having a program stored thereon in a non-transitory manner according to a third aspect of the present disclosure is a computer readable medium having a program stored thereon in a non-transitory manner, the program being executed by a processor mounted on a computer. The program, by being executed by the processor, causes the computer to perform: obtaining a feature amount of a target component included in a target sample and a measurement value of the target component from a first chromatogram, the first chromatogram being obtained by analyzing the target sample at a first timing under a first analysis condition; and obtaining a feature amount of a first reference component included in a standard sample, a feature amount of a second reference component included in the standard sample, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition. The program, by being executed by the processor, causes the computer to perform correcting the measurement value of the target component based on the feature amount of the target component, the feature amount of the first reference component, the feature amount of the second reference component, the measurement value of the first reference component at each timing, and the measurement value of the second reference component at each timing. About the target component, the first reference component and the second reference component, a measurement value of each component is a value related to an amount of the corresponding component, and a feature amount of each component is a retention time and/or a mass-to-charge ratio of the corresponding component.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram of an analysis system according to an embodiment.

FIG. 2 is a diagram for illustrating a procedure of preparing a pooled QC.

FIG. 3 is a diagram for illustrating an order of measurement of the pooled QC and samples.

FIG. 4 is a diagram for illustrating a method of correcting measurement values of the samples based on measurement values of the pooled QC in a comparative example.

FIG. 5 is a diagram for illustrating an order of measurement of samples.

FIG. 6 is a diagram showing an example of chromatograms obtained by analyzing the samples.

FIG. 7 is a diagram showing an example of chromatograms of the standard sample that is analyzed in different batches.

FIG. 8 is a diagram showing an example of chromatograms of the samples to be measured that are analyzed in different batches.

FIG. 9 is a diagram showing an example of correction of a target component in a target sample based on a weight.

FIG. 10 is a flowchart showing data processing according to the embodiment.

FIG. 11 is a flowchart showing a subroutine of step S16 shown in FIG. 10.

### DESCRIPTION OF THE PREFERRED EMBODIMENTS

Hereinafter, an embodiment of the present disclosure will be described in detail with reference to the drawings. Although a chromatograph mass spectrometer is described below as an example of an analysis device, the present disclosure is not limited thereto and is applicable to any analysis device. In the drawings, the same or corresponding portions are denoted by the same reference characters and description thereof will not be repeated.

### [Overall Configuration of Analysis System]

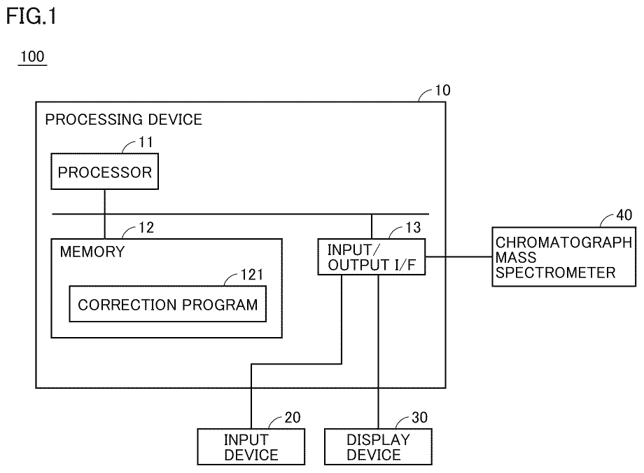

FIG. 1 is a block diagram showing a configuration of an analysis system 100 according to an embodiment. Referring to FIG. 1, analysis system 100 includes a processing device 10, an input device 20, a display device 30, and a chromatograph mass spectrometer 40. Analysis system 100 corrects an error caused by a difference in timing of measurement, about measurement values of samples obtained by chromatograph mass spectrometer 40. Processing device 10 may be incorporated into chromatograph mass spectrometer 40.

Processing device 10 includes a processor 11, a memory 12 and an input/output interface (I/F) 13. These components are communicatively connected to each other through a bus.

Processor 11 is an example of an electrical circuit and controls the operation of processing device 10 by executing a given program. The program executed by processor 11 may be stored in memory 12, or may be stored in a storage device (not shown) that is external to processing device 10. Processor 11 is, for example, a central processing unit (CPU).

Memory 12 can store the program to be executed by processor 11, and analysis data obtained by analysis of a sample by chromatograph mass spectrometer 40. The analysis data includes, for example, prepared chromatograms, prepared mass spectrum data, and measurement values of components. The program stored in memory 12 includes a correction program 121. Memory 12 includes a volatile memory (e.g., a random access memory (RAM)) and a non-volatile memory (e.g., a read only memory (ROM), a hard disk drive and a solid state drive). The above-described program may be stored in an external storage device that can be accessed by processor 11.

Input/output I/F 13 is an interface for exchanging various types of data between processor 11 and the devices connected to input/output I/F 13. Input device 20, display device 30 and chromatograph mass spectrometer 40 are connected to input/output I/F 13. Input/output I/F 13 is implemented by, for example, a terminal block, a connector and a network adapter. Exchanging the data through input/output I/F 13 may be performed wirelessly using Bluetooth (registered trademark), wireless LAN or the like, or may be performed in a wired manner using a universal serial bus (USB) or the like. Processing device 10 can receive, through input/output I/F 13, measurement values obtained by a device other than chromatograph mass spectrometer 40, and perform data processing on the measurement values.

Input device 20 receives input of information from a user to processing device 10. The information includes, for example, the total number of samples, types of samples, and feature amounts of components. The feature amounts of components will be described in detail below. Input device 20 is implemented by, for example, a touch panel, a mouse and a keyboard.

Display device 30 displays information in accordance with an instruction from processing device 10. The information includes, for example, chromatograms of samples, mass spectrums of components included in the samples, measurement values of a prescribed component before correction, and measurement values of the prescribed component after correction. Display device 30 is implemented by, for example, a liquid crystal display that can display an image.

Chromatograph mass spectrometer 40 analyzes a sample under a prescribed analysis condition and prepares analysis data. The analysis condition includes, for example, a device to be used in analysis, a length of a column, a type of a carrier of the column, a diameter of the column, a temperature of the column, a type of a solvent, and a flow rate of the solvent. The analysis data includes, for example, a chromatogram of the sample and mass spectrum data indicating a mass distribution of an ion derived from a component included in the sample. The analysis data is transmitted to processing device 10. Processing device 10 extracts a feature amount and a measurement value of the component included in the sample from the analysis data of the sample. The feature amount of the component is a value related to the analysis condition and physicochemical properties of the component, and include, for example, the retention time, a mass-to-charge ratio, and a mass-to-charge ratio of a product ion. The measurement value of the component is a value related to an amount of the component, and include, for example, a peak area and a peak intensity of the component in a chromatogram. Chromatograph mass spectrometer 40 is, for example, a liquid chromatography mass spectrometer, a gas chromatography mass spectrometer, a high performance liquid chromatography-tandem mass spectrometer, and a gas chromatography-tandem mass spectrometer.

### COMPARATIVE EXAMPLE

In measurement using a chromatograph mass spectrometer, contamination may occur in a mass spectrometry unit in the process of repeated measurement and the contamination may affect an analysis result. For example, even if the same sample is measured, measurement values obtained by measuring the sample on different days do not match with each other in some cases. That is, the measurement values obtained by the chromatograph mass spectrometer may include an error caused by a difference in timing of measurement and thus a difference in state of the analysis device even if the analysis condition is the same.

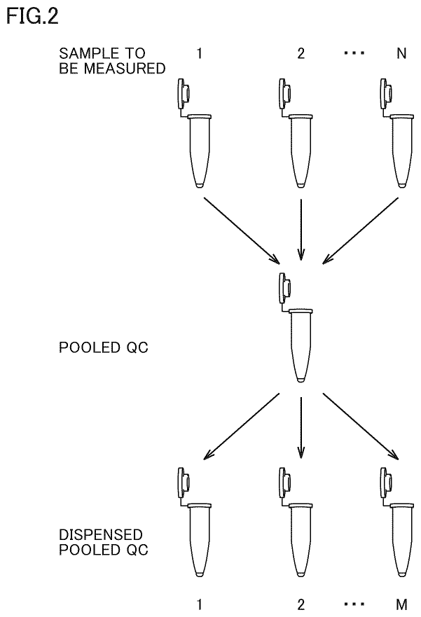

As a method of correcting the above-described error, the technique for correcting measurement values of samples based on measurement values of a standard sample called “pooled QC” as described in “Procedures for large-scale metabolic profiling of serum and plasma using gas chromatography and liquid chromatography coupled to mass spectrometry” by Dunn, Warwick B., et al., Nature protocols 6.7 (2011): 1060-1083 has been known. FIG. 2 is a diagram for illustrating a procedure of preparing a pooled QC. Let us assume that there are N samples to be measured. As shown in FIG. 2, a pooled QC is prepared by mixing all of the samples in equal amounts. Since all of the samples are mixed in equal amounts, an amount of each component included in the pooled QC is an average of all of the samples about this component. That is, the measurement values of the pooled QC are close to an average value of the measurement values of all of the samples, which makes it possible to prevent the measurement values of the pooled QC from significantly deviating from the measurement values of the samples. In addition, since the pooled QC is prepared by mixing all of the samples, a component included in at least one of the samples is included in the pooled QC. Therefore, even when a component to be subjected to correction is unknown at the start of measurement, measurement values of the component can be subjected to correction processing after the end of analysis. The prepared pooled QC is dispensed into the appropriate number of pieces. In FIG. 2, the prepared pooled QC is divided into M pieces.

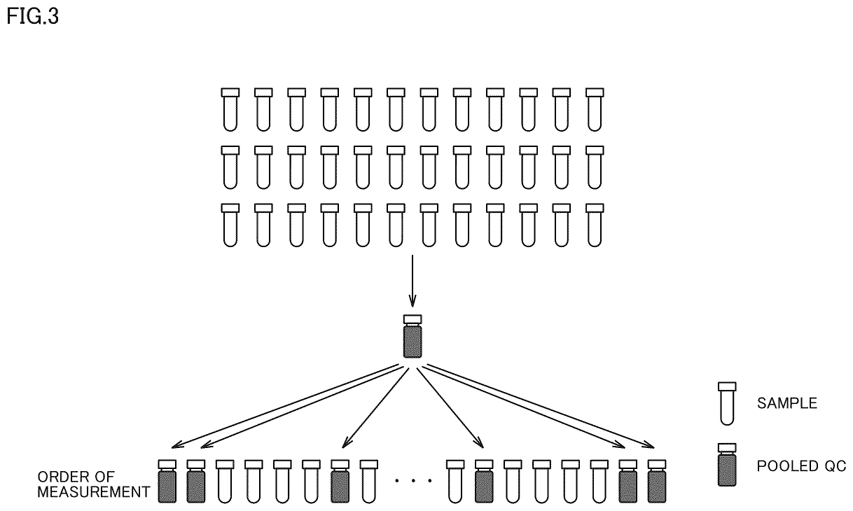

The chromatograph mass spectrometer analyzes the pooled QC before and after analysis of the samples, and sequentially obtains measurement values of the samples and measurement values of the pooled QC. FIG. 3 is a diagram for illustrating an order of measurement of the pooled QC and the samples. In FIG. 3, a white container represents the sample to be measured, and a gray container represents the pooled QC. An operator extracts an equal amount of solution from each of thirty-six samples and prepares one pooled QC. The prepared pooled QC is divided into the appropriate number of pieces and is subjected to measurement at an appropriate timing before and after measurement of the samples. For example, as shown in FIG. 3, the chromatograph mass spectrometer performs two consecutive analyses of the pooled QC before the start of analysis of the samples, and then, performs one analysis of the pooled QC every time the chromatograph mass spectrometer analyzes four samples. After the last sample is analyzed, the chromatograph mass spectrometer performs two consecutive analyses of the pooled QC.

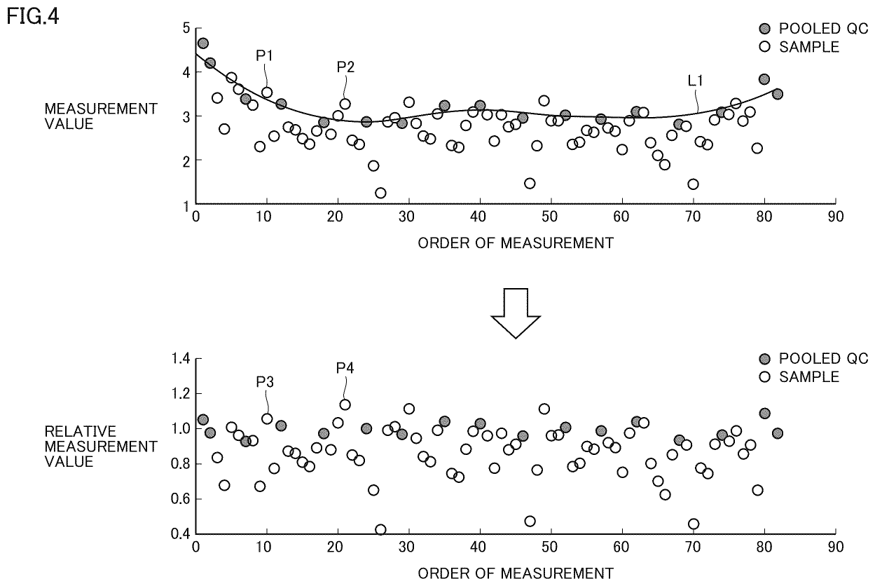

By performing a series of analysis as described above, the measurement values of the samples and the measurement values of the pooled QC are sequentially obtained. Processing device 10 corrects the measurement values of the samples based on the measurement values of the pooled QC. FIG. 4 is a diagram for illustrating a method of correcting the measurement values of the samples based on the measurement values of the pooled QC. In the graph shown in the upper part of FIG. 4, the obtained measurement values are shown in the order of analysis of the samples and the pooled QC. A white circle represents the measurement value of the sample, and a gray circle represents the measurement value of the pooled QC. Here, the measurement value of the sample in a tenth analysis indicated by a point P1 is larger than the measurement value of the sample in a twenty-first analysis indicated by a point P2, for example.

Ideally, the measurement values of the pooled QC should be equal to each other even if the pooled QC is measured at any timing. Therefore, in order to correct the measurement values of the samples, LOESS smoothing is performed using only the measurement values of the pooled QC, to calculate an approximate curve L1. Based on calculated approximate curve L1, the measurement values of the samples are corrected. The graph shown in the lower part of FIG. 4 shows relative measurement values of the samples after correction. The relative measurement values in this graph are normalized values when a value indicated by approximate curve L1 is 1. In the graph shown in the lower part of FIG. 4, the measurement values of the pooled QC are corrected to be substantially constant.

A point P3 represents the measurement value of the sample in the tenth analysis after correction, and a point P4 represents the measurement value of the sample in the twenty-first analysis after correction. Although point P1 is larger than point P2 before correction, point P3 is smaller than point P4 after correction. As described above, the use of the QC-RLSC method makes it possible to correct the error caused by a difference in timing of analysis, which is included in each of the measurement values, and improve the accuracy of measurement.

In a correction method using measurement values of a standard sample like the pooled QC, measurement values of a prescribed component of a target sample are corrected based on measurement values of the prescribed component of the standard sample. For example, in measurement values of the chromatograph mass spectrometer, a component A and a component B may be different in detection sensitivity and ionization efficiency. That is, an error caused by a difference in timing of analysis, which is included in measurement values of component A may be different from an error caused by a difference in timing of analysis, which is included in measurement values of component B. Therefore, when the error of the measurement values of component B is corrected based on the error of the measurement values of component A, the accuracy of the measurement values of component B after correction may be insufficient. Therefore, it is desirable that the standard sample should include a component to be subjected to correction.

However, when a sample to be analyzed is newly added after the standard sample is prepared, a component to be subjected to correction may not be included in the standard sample. In addition, in the above-described QC-RLSC method, a very small amount of component included in a part of the samples is included in the pooled QC in a very small amount. Therefore, in measurement of the pooled QC, the component may be equal to or lower than the detection sensitivity and measurement values of the component in the pooled QC may not be obtained.

### Data Processing Method According to Embodiment

Thus, in a data processing method according to the present embodiment, a variation rate of a prescribed component to be measured is estimated based on variation rates of measurement values of two or more types of reference components included in a standard sample. According to the data processing method, even when the prescribed component is not included in the standard sample, the user can correct a measurement value of the prescribed component in the sample to be measured.

In the data processing method according to the present embodiment, when the variation rate of the prescribed component is estimated, degrees of influence (weights) calculated based on a feature amount of the prescribed component and feature amounts of the reference components are assigned to the reference components in the standard sample. Importance is placed on the variation rates of the reference components having the characteristics similar to those of the prescribed component, and thus, the variation rate of the prescribed component can be estimated with higher accuracy.

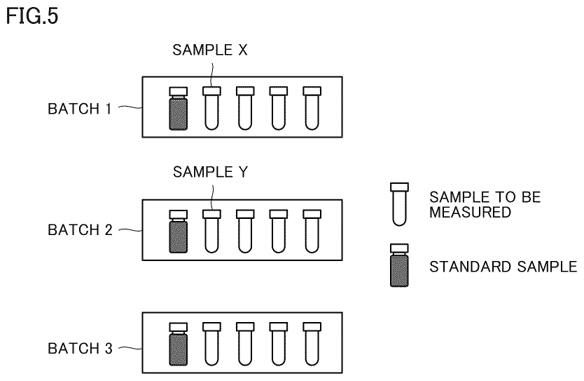

FIG. 5 is a diagram for illustrating samples to be analyzed by chromatograph mass spectrometer 40. In FIG. 5, a sample to be measured is indicated by a white container, and a standard sample is indicated by a black container. The sample to be measured includes a prescribed component. Although the standard sample includes two or more reference components, the standard sample does not include the prescribed component.

Let us assume that five analyses are performed in one analysis group, and the one analysis group is referred to as a batch. At least in the same batch, the samples are analyzed under the same analysis condition. The analyses in the same batch are performed consecutively, and thus, the analyses in the same batch are assumed to include no error caused by a difference in timing of measurement. Therefore, a measurement value of a sample Y belonging to a batch 2 with respect to a measurement value of a sample X belonging to a batch 1 includes an error caused by a difference in timing of analysis.

In one batch, the standard sample is analyzed once, and subsequently, the sample to be measured is analyzed four times in succession. Therefore, when one batch is analyzed, processing device 10 obtains measurement values of the two or more reference components included in the standard sample and measurement values of the prescribed component of the samples. Data processing according to the present embodiment is, for example, used to compare a measurement value of the prescribed component of sample X belonging to batch 1 with a measurement value of the prescribed component of sample Y belonging to batch 2. Processing for correcting an error in measurement value caused by a difference in batch will be described below.

### <1. Analysis of Samples by Chromatograph Mass Spectrometer>

As described above, the standard sample and the sample to be measured are analyzed in order by chromatograph mass spectrometer 40. Chromatograph mass spectrometer 40 measures the standard sample and the sample to be measured, and prepares chromatograms of these samples. Each of the prepared chromatograms includes a chromatogram indicating a relationship between an ion detection intensity and a retention time per mass-to-charge ratio, and a total ion chromatogram indicating a relationship between detection intensities of all ions introduced into chromatograph mass spectrometer 40 and a retention time. Furthermore, chromatograph mass spectrometer 40 detects a product ion, with an ion having a detection intensity of a prescribed value or more in the chromatogram per mass-to-charge ratio being a precursor ion. Measurement data obtained by chromatograph mass spectrometer 40 includes the above-described chromatogram indicating the relationship between the ion detection intensity and the retention time per mass-to-charge ratio, the above-described total ion chromatogram, and a mass-to-charge ratio of the product ion when the ion having the detection intensity of the prescribed value or more is the precursor ion.

### <2. Extraction of Feature Amounts>

Processing device 10 automatically recognizes peaks on the chromatograms and extracts a feature amount for each peak from the analysis data obtained by chromatograph mass spectrometer 40.

In the total ion chromatogram for each sample prepared by chromatograph mass spectrometer 40, processing device 10 identifies each peak of each component included in the sample. The ion mass-to-charge ratio corresponding to the retention time of the identified peak is derived from the chromatogram prepared per mass-to-charge ratio. For example, in the present embodiment, an average value or a median value of mass-to-charge ratios of detected ions at a retention time corresponding to a peak recognized in the total ion chromatogram is defined as a mass-to-charge ratio of the peak. Furthermore, processing device 10 obtains, as a feature amount, the mass-to-charge ratio of the product ion obtained by chromatograph mass spectrometer 40, with the ion having the mass-to-charge ratio being the precursor ion.

Alternatively, the user may input, to input device 20, a feature amount for specifying the prescribed component to be subjected to correction and a feature amount for specifying the reference components serving as a reference of correction. In this case, processing device 10 receives the feature amounts input by the user and identifies peaks having these feature amounts from the chromatogram. Processing device 10 uses the identified peaks as the peaks derived from the prescribed component and the reference components in the subsequent process.

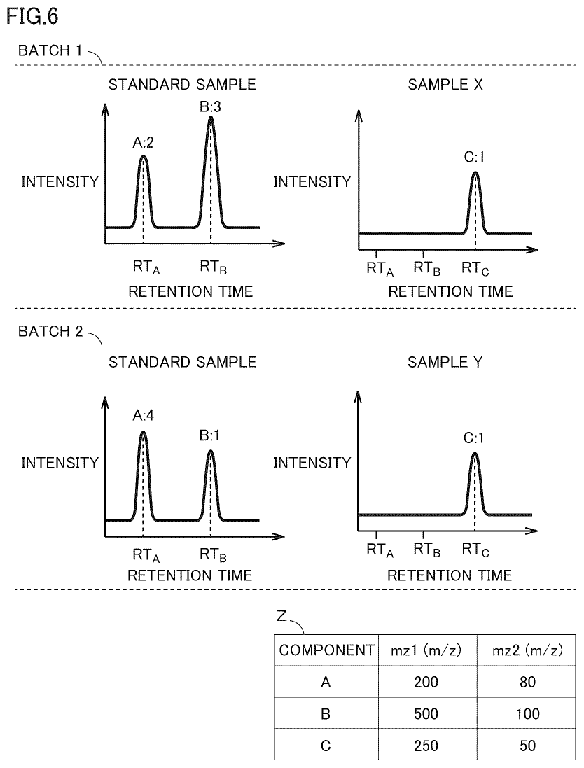

FIG. 6 is a diagram showing an example of the total ion chromatogram prepared by analysis of the standard sample and the sample to be measured by chromatograph mass spectrometer 40. A process in which processing device 10 obtains the feature amount and the measurement value of each peak from the chromatogram will be described with reference to FIG. 6.

First, processing device 10 recognizes peaks in the chromatogram prepared by analysis of the standard sample by chromatograph mass spectrometer 40 in batch 1. Processing device 10 identifies a peak having a retention time of RT_{A} and a peak having a retention time of RT_{B}. As shown in FIG. 6, each peak has a width on the chromatogram. Although the retention time of the peak is defined as the time of a vertex of the peak in the present embodiment, the present disclosure is not limited thereto and the retention time may, for example, be defined as a starting point or an end point of the peak. Here, the peak having a retention time of RT_{A} is derived from a component A and the peak having a retention time of RT_{B} is derived from a component B.

Next, based on the chromatogram per mass-to-charge ratio (not shown) prepared by chromatograph mass spectrometer 40, mz1, which is a mass-to-charge ratio of each of component A having a retention time of RT_{A} and component B having a retention time of RT_{B}, is determined. Furthermore, mz2, which is a mass-to-charge ratio of the product ion when each of these components is the precursor ion, is obtained from the analysis data of chromatograph mass spectrometer 40. Generally, one or more product ions are detected. In the present embodiment, chromatograph mass spectrometer 40 analyzes a corresponding component as a precursor ion and uses, as mz2, a mass-to-charge ratio of an ion having the highest detection intensity, of the detected product ions. The values of mz1 and mz2 obtained by processing device 10 are shown in a box Z in FIG. 6.

In addition, processing device 10 calculates a peak area, which is an area of a region surrounded by each peak and a line segment drawn from a starting point to an end point of the peak. The peak area is proportional to an amount of the component. That is, the peak area can be regarded as a measurement value. The value of the highest detection intensity in a target peak may be regarded as a measurement value of a component that causes the peak.

In FIG. 6, processing device 10 calculates an area formed by the peak derived from component A of the standard sample in batch 1 as 2, and calculates an area formed by the peak derived from component B of the standard sample in batch 1 as 3. In FIG. 6, the value of the area of each peak is shown at the vertex portion of the peak.

Processing device 10 performs the above-described processing on the chromatograms of sample X in batch 1, the standard sample in batch 2 and sample Y in batch 2 prepared by chromatograph mass spectrometer 40, to obtain feature amounts and measurement values of the components included in these samples. As shown in FIG. 6, processing device 10 obtains a retention time RT_{C}, mz1, mz2, and a measurement value of a component C, which is a component that is included in both sample X and sample Y and is not included in the standard sample, from the chromatogram of sample X. Processing device 10 also obtains measurement values of component A and component B in batch 2 from the standard sample in batch 2. Furthermore, processing device 10 obtains a measurement value of component C of sample Y from the chromatogram of sample Y.

Processing device 10 sets component A and component B included in the standard sample as reference components. In addition, processing device 10 sets component C that is not included in the standard sample and is included in sample X and sample Y as a prescribed component.

The feature amount is a value that may vary depending on the analysis condition. Therefore, the feature amount of component A in batch 1 and the feature amount of component A in batch 2 do not match each other in some cases. In such a case, in the subsequent process, the feature amount of component A may be an average of the feature amount of component A in batch 1 and the feature amount of component A in batch 2, or may be one of the feature amount of component A in batch 1 and the feature amount of component A in batch 2.

<3. Weighting of Reference Components with Respect to Prescribed Component>

A weight indicating a degree of influence of each reference component on the prescribed component is calculated based on the feature amount of each reference component and the feature amount of the prescribed component. Processing device 10 assigns a greater weight to a reference component closer in value of a common feature amount to the prescribed component, of the two or more reference components. For example, when the first reference component and the second reference component are included in the standard sample and when a difference between a value of a prescribed feature amount of the first reference component and a value of the prescribed feature amount of the prescribed component is smaller than a difference between a value of the prescribed feature amount of the second reference component and a value of the prescribed feature amount of the prescribed component, a greater weight is assigned to the first reference component. In this case, the first reference component is closer in value of the common feature amount to the prescribed component than the second reference component. Determination of the closeness of the value of the feature amount between each reference component and the prescribed component is not limited to comparison based on the difference. For example, when a quotient calculated by dividing a value of a prescribed feature amount of the first reference component by a value of the prescribed feature amount of the prescribed component is closer to 1 than a quotient calculated by dividing a value of the prescribed feature amount of the second reference component by a value of the prescribed feature amount of the prescribed component, it may be determined that the first reference component is closer in amount of the common feature amount to the prescribed component than the second reference component.

In FIG. 6, when attention is given to the retention time, RT_{A}<RT_{B}<RT_{C}. That is, when the retention time is used as an indicator, component A is considered as a component having a feature amount similar to that of component C in comparison with component B. Therefore, processing device 10 calculates the weights such that a greater weight is assigned to component B than component A in terms of the retention time.

In addition, in FIG. 6, when attention is given to mz1, mz1 of component C is closer to mz1 of component A than mz1 of component B. That is, when mz1 is used as an indicator, component B is considered as a component having a feature amount similar to that of component C in comparison with component A. Therefore, processing device 10 calculates the weights such that a greater weight is assigned to component A than component B in terms of mz1. When mz2 is used as an indicator, processing device 10 calculates the weights such that a greater weight is assigned to component A than component B, similarly to the case in which mz1 is used as an indicator.

The weight of the reference component is calculated for each reference component by using the retention time, mz1 and mz2. Specifically, for example, when the retention time, mz1 and mz2 are used as feature amounts and a Gaussian function is used, the weight of the reference component with respect to the target component is determined in accordance with Equation (1) below:

$$exp ( - 1 * ( \frac{{( {RT}_{Q} - {RT}_{T} )}^{2}}{{σ}_{RT}^{2}} + \frac{{( mz {1}_{Q} - mz {1}_{T} )}^{2}}{{σ}_{mz 1}^{2}} + \frac{{( mz {2}_{Q} - mz {2}_{T} )}^{2}}{{σ}_{mz 2}^{2}} ) ) + C . \qquad ( 1 )$$

In Equation (1), RT_{T} represents a retention time of the target component, RT_{Q} represents a retention time of the reference component, mz1_{T} represents mz1 of the target component, mz1_{Q} represents mz1 of the reference component, mz2_{T} represents mz2 of the target component, mz2_{Q} represents mz2 of the reference component, and σ_{RT}, σ_{mz1}, σ_{mz2}, and C are prescribed numbers.

σ_{RT}, σ_{mz1} and σ_{mz2} are numbers for adjusting the weights. By determining the magnitude of these numbers, the user can adjust the degree of influence of each feature amount on determination of the weight of the reference component. For example, as shown in Equation (1), as the value of ORT is made larger in determination of the weight of the reference component, the degree of influence of the retention time becomes stronger. By adjusting the values of σ_{RT}, σ_{mz1} and σ_{mz2}, the user can adjust the degree of influence on determination of the weight for each feature amount.

In addition, C is a constant greater than 0 and prevents the weight from becoming zero when a difference between the feature amount of the prescribed component and the feature amount of the reference component is large.

The Gaussian function is used in Equation (1) to calculate the weight of the reference component. However, the present disclosure is not limited to the use of the Gaussian function, and a Cauchy function or a T distribution may be used.

For example, when the Cauchy function is used, the weight of the reference component is determined in accordance with Equation (2) below:

$$\frac{1}{1 + ( \frac{{( {RT}_{Q} - {RT}_{T} )}^{2}}{{σ}_{RT}^{2}} + \frac{{( mz {1}_{Q} - mz {1}_{T} )}^{2}}{{σ}_{mz 1}^{2}} + \frac{{( mz {2}_{Q} - mz {2}_{T} )}^{2}}{{σ}_{mz 2}^{2}} )} + C . \qquad ( 2 )$$

In Equation (2), RT_{T} represents a retention time of the target component, RT_{Q} represents a retention time of the reference component, mz1_{T} represents a mass-to-charge ratio of the target component, mz1_{Q} represents a mass-to-charge ratio of the reference component, mz2_{T} represents mz2 of the target component, mz2_{Q} represents mz2 of the reference component, and σ_{RT}, σ_{mz1}, σ_{mz2}, and C are prescribed numbers.

In accordance with the properties of the prescribed component, the user can select the function used for weighting of the reference component.

### <4. Determination of Weighting Coefficients of Reference Components Based on Weighting>

Based on the calculated weight of each reference component, processing device 10 determines a weighting coefficient of each reference component. The weighting coefficient is determined based on a ratio between the weights, for example. In FIG. 6, a weighting coefficient F_{A} of component A is expressed as W_{A}/W_{A}+W_{B}, where W_{A} represents a weight of component A with respect to component C and W_{B} represents a weight of component B with respect to component C. A weighting coefficient F_{B} of component B is expressed as W_{B}/W_{A}+W_{B}. A method of determining the weighting coefficient is not limited to the above-described method.

### <5. Calculation of Variation Rates of Reference Components>

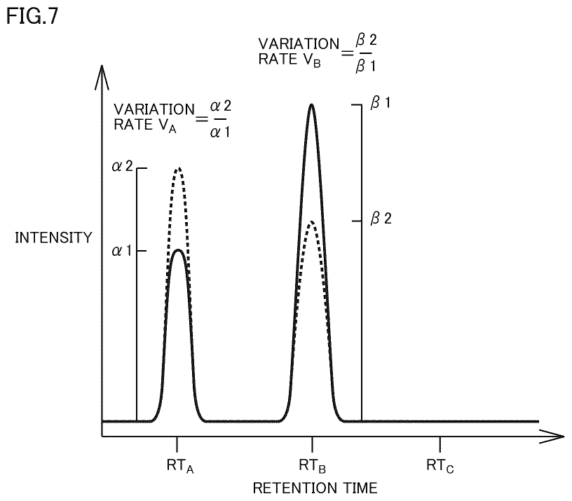

Next, variation rates of the reference components between the batches are calculated. FIG. 7 is a diagram for illustrating the variation rates of the reference components. In FIG. 7, the chromatograms of the standard sample obtained in the different batches are shown in an overlapped manner. The chromatogram obtained in batch 1 is indicated by a solid line and the chromatogram obtained in batch 2 is indicated by a dotted line. The standard sample includes component A having a retention time of RT_{A} and component B having a retention time of RT_{B}. The standard sample does not include component C having a retention time of RT_{C}.

As shown in the chromatograms in FIG. 7, although the same standard sample is analyzed in batch 1 and batch 2, the peak areas of component A and component B are different. For example, a variation rate V_{A} of the measurement value of component A in batch 2 with respect to the measurement value of component A in batch 1 is expressed as α2/α1, where α1 represents the measurement value of component A in batch 1 and α2 represents the measurement value of component A in batch 2. Similarly, a variation rate V_{B} of the measurement value of component B in batch 2 with respect to the measurement value of component B in batch 1 is expressed as β2/β1, where β1 represents the measurement value of component B in batch 1 and β2 represents the measurement value of component B in batch 2.

### <6. Estimation of Variation Rate of Prescribed Component Between Batches>

A method of estimating a variation rate of the prescribed component by using the weighting coefficients of the reference components and the variation rates of the reference components will be described. The variation rate of the prescribed component corresponds to a measurement value of component C in batch 2, supposing that the standard sample includes component C and a measurement value of component C in batch 1 is 1.

The variation rate of the prescribed component is, for example, a sum of the variation rates of the reference components multiplied by the weighting coefficients of the reference components. Specifically, in FIG. 6, a variation rate V_{C} of component C in batch 2 with respect to batch 1 is expressed as V_{C}=F_{A}V_{A}+F_{B}V_{B}, where F_{A} represents the weighting coefficient of component A, V_{A} represents the variation rate of component A, F_{B} represents the weighting coefficient of component B, and V_{B} represents the variation rate of component B.

### <7. Correction of Measurement Values of Prescribed Component Between Batches>

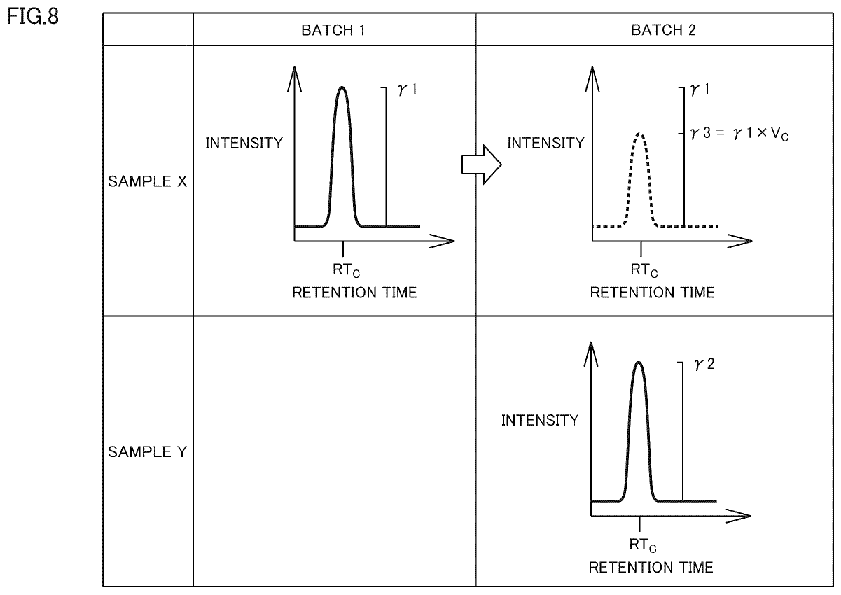

The measurement values obtained in the different batches are corrected based on the estimated variation rate of the prescribed component. FIG. 8 is a diagram for illustrating a method of correcting the measurement values of the prescribed component based on the estimated variation rate of the prescribed component.

FIG. 8 shows the chromatograms prepared by analysis of sample X and sample Y by chromatograph mass spectrometer 40. As shown in FIG. 8, a measurement value of component C of sample X in batch 1 is indicated by γ1 and a measurement value of component C of sample Y in batch 2 is indicated by γ2. The measurement values obtained in the different batches include an error caused by a difference in timing of analysis. Therefore, when an amount of component C included in sample X and an amount of component C included in sample Y are compared, γ1 and γ2 cannot be simply compared. Therefore, estimation of a measurement value obtained if sample X is analyzed in batch 2 is necessary.

Thus, processing device 10 multiplies measurement value γ1 of component C of sample X by estimated variation rate V_{C} of component C, to obtain a measurement value γ3 of component C of sample X after correction. That is, measurement value γ3 of component C of sample X after correction is expressed as γ3=γ1V_{C}.

When the amount of component C included in sample X and the amount of component C included in sample Y are compared, the user needs to compare γ2 with γ3 obtained by multiplying γ1, which is the measurement value of component C of sample X, by variation rate V_{C}, as shown in FIG. 8.

The above-described estimated variation rate of the prescribed component is also used as a correction coefficient used to correct the measurement value.

In the above-described example, the difference between the feature amount of the reference component and the feature amount of the prescribed component is used to determine the weight. However, a ratio between the feature amount of the reference component and the feature amount of the prescribed component may be used. The ratio between the feature amount of the reference component and the feature amount of the prescribed component corresponds to a difference between logarithms of these feature amounts.

In the above-described example, the data processing according to the present embodiment is applied to correction of the measurement values in analysis of the samples between the batches. However, the data processing according to the present embodiment may be applied to correction of the measurement values in analysis of the samples in one batch. For example, the data processing may be used to correct a measurement value of a prescribed component of each sample based on a measurement value of a reference component included in a pooled QC in data obtained by sequentially measuring the samples and the pooled QC as in the example shown in FIG. 3. In this case, it is desirable that the samples be analyzed under the same analysis condition.

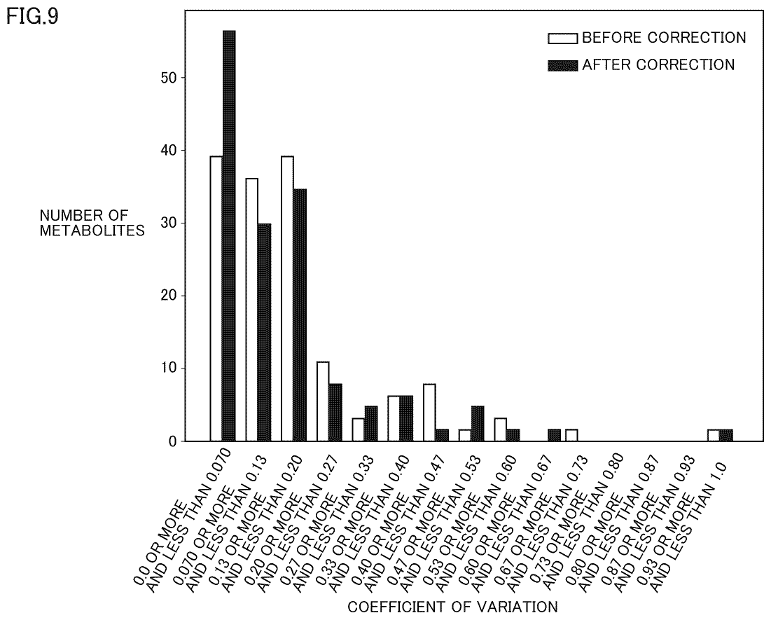

FIG. 9 is a diagram showing an example of a result of correction by the data processing method. The amount of metabolites included in human plasma was measured by liquid chromatography tandem mass spectrometry. A prescribed substance in the plasma was set as a reference component and obtained measurement values of the metabolites were corrected. FIG. 9 shows coefficients of variation of the measurement values of the metabolites. The white bar represents the coefficients of variation of the measurement values of the metabolites before correction, and the black bar represents the coefficients of variation of the measurement values of the metabolites after correction. The coefficient of variation is a value indicating the dispersion of data, and as the coefficient of variation becomes smaller, the dispersion of data becomes smaller. FIG. 9 shows that the number of metabolites having the coefficient of variation of 0.0 or more and less than 0.0070 becomes larger as a result of correction. That is, it is estimated that the above-described correction leads to a reduction in error of the measurement value caused by a difference in timing of analysis and a reduction in dispersion of data.

### [Flow of Data Processing]

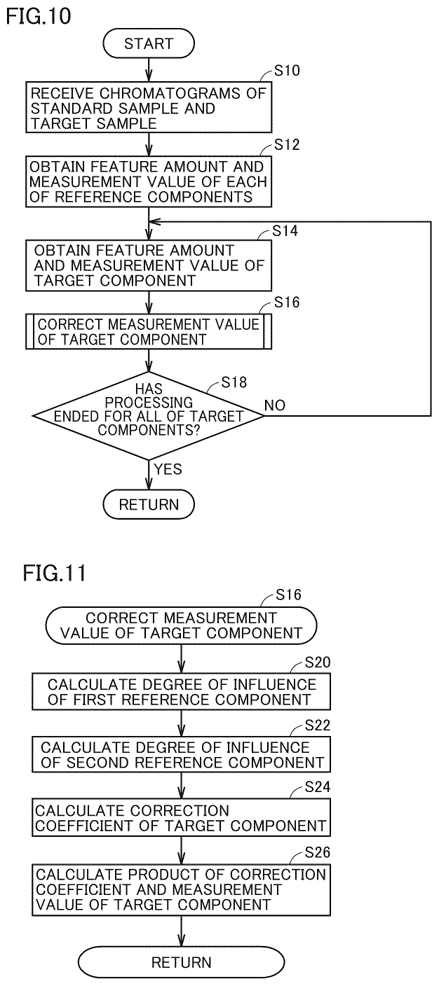

FIG. 10 is a diagram showing a flowchart of an example of data processing for measurement values obtained by analysis of samples by chromatograph mass spectrometer 40. In one implementation, a data processing subroutine in FIG. 10 is called from a main routine and executed when the processor of processing device 10 executes correction program 121. Processing device 10 is an example of an information processing device. The standard sample includes a first reference component and a second reference component, and the target sample to be measured includes a target component.

In the flowchart below, a description will be given of processing for correcting a measurement value of the target component of the target sample when the standard sample is analyzed by chromatograph mass spectrometer 40 in each of batch 1 and batch 2 and the target sample is analyzed by chromatograph mass spectrometer 40 in batch 2.

In step S10, processing device 10 receives chromatograms of the standard sample and the target sample analyzed by chromatograph mass spectrometer 40 in each of the different batches.

In step S12, processing device 10 obtains a feature amount of the first reference component, a feature amount of the second reference component, a measurement value of the first reference component in each batch, and a measurement value of the second reference component in each batch. Each of the feature amounts may be extracted by processing device 10 from the chromatogram received in step S10, or may be input to input device 20 by the user. Each of the feature amounts includes, for example, a retention time when a corresponding one of the components is subjected to chromatograph, a mass-to-charge ratio of the corresponding one of the components, and a mass-to-charge ratio of a product ion when the corresponding one of the components is a precursor ion. Each of the measurement values includes, for example, a peak area of the corresponding one of the components on the chromatogram. In the steps below, E target components are processed one by one.

In step S14, processing device 10 obtains a feature amount and a measurement value of one of the E target components from the chromatogram received in step S10.

In step S16, processing device 10 corrects the measurement value of the target component by using the feature amount of the first reference component, the feature amount of the second reference component, the measurement value of the first reference component in each batch, and the measurement value of the second reference component in each batch that are obtained in step S12, and the feature amount of the target component that is obtained in step S14. FIG. 11 shows a subroutine of the correction processing in step S16.

Referring to FIG. 11, in step S20, processing device 10 calculates a degree of influence of the first reference component on the target component by using the feature amount of the target component and the feature amount of the first reference component.

In step S22, processing device 10 calculates a degree of influence of the second reference component on the target component by using the feature amount of the target component and the feature amount of the second reference component.

In step S24, processing device 10 calculates a correction coefficient of the target component by using the degree of influence of the first reference component calculated in step S20 and the degree of influence of the second reference component calculated in step S22.

In step S26, processing device 10 multiplies the measurement value of the target component by the correction coefficient of the target component. Thereafter, processing device 10 ends the subroutine of the correction processing and returns the control to FIG. 10.

Referring to FIG. 10, in step S18, processing device 10 determines whether the processing has ended for the E target components received in step S12. When the processing has ended for all of the target components (YES in step S18), processing device 10 ends the data processing subroutine and returns the process to the main routine. Otherwise (NO in step S18), processing device 10 returns the process to step S14.

In the above-described data processing, when the standard sample does not include the component to be subjected to correction, the measurement value of the component to be subjected to correction can be corrected based on the measurement values of the reference components included in the standard sample. Therefore, when a sample including a prescribed component that is not included in the standard sample is analyzed after the standard sample is prepared, the cost required to prepare a new standard sample can be reduced.

In addition, in the above-described data processing, weights of the reference components included in the standard sample are determined based on information obtained by analyzing the reference components and the component to be subjected to correction. Therefore, even when the component to be subjected to correction is unknown and chemical properties thereof are unknown, the above-described data processing method is applicable.

The above-described data processing method can, for example, be used to analyze food. For example, let us assume that the amount of components included in a genetically modified vegetable is measured. As a result of genetic modification, the genetically modified vegetable may include components different from those of the vegetable before genetic modification. In such a case, a standard sample including a typical component included in the target vegetable is prepared, and based on measurement values of this component, measurement values of the components included in the genetically modified vegetable can be corrected. Even when an analyst cannot predict the components included in the genetically modified vegetable, the measurement values of the components included in the vegetable can be corrected by using the above-described data processing method.

In addition, the above-described data processing method can, for example, be used to analyze an additive included in an imported material. For example, when pulp is imported, an additive included in the pulp may vary depending on an import source and the time of import. Thus, a standard sample including a typical component included in the pulp is prepared, and based on measurement values of this component, measurement values of the additive included in the pulp can be corrected. Even when the additive included in the pulp is unknown before measurement, the measurement values of the additive included in the pulp can be corrected by using the above-described data processing method.

### [Aspects]

It will be appreciated by a person skilled in the art that the illustrative embodiments described above provide specific examples of the following aspects.

(Clause 1) A data processing method according to an aspect is a data processing method of correcting a measurement value of a target component in a target sample by using a standard sample including a first reference component and a second reference component, the measurement value of the target component being obtained by an analysis device including a mass spectrometer or a chromatograph mass spectrometer. About the target component, the first reference component and the second reference component, a measurement value of each component may be a value related to an amount of the corresponding component, and a feature amount of each component may be a retention time and/or a mass-to-charge ratio of the corresponding component. The data processing method may include: obtaining a feature amount of the target component and the measurement value of the target component from a first chromatogram, the first chromatogram being obtained by analyzing the target sample at a first timing under a first analysis condition; obtaining a feature amount of the first reference component, a feature amount of the second reference component, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition; and correcting the measurement value of the target component based on the feature amount of the target component, the feature amount of the first reference component, the feature amount of the second reference component, the measurement value of the first reference component at each timing, and the measurement value of the second reference component at each timing.

According to the data processing method described in Clause 1, the measurement value of the target component in the target sample can be corrected by using the result obtained by analyzing the standard sample that does not include the target component.

(Clause 2) In the data processing method described in Clause 1, the correcting may include: calculating a first degree of influence by using the feature amount of the target component and the feature amount of the first reference component, the first degree of influence being a degree of influence of the first reference component; calculating a second degree of influence by using the feature amount of the target component and the feature amount of the second reference component, the second degree of influence being a degree of influence of the second reference component; calculating a correction coefficient of the target component based on the measurement value of the first reference component at each timing, the measurement value of the second reference component at each timing, the first degree of influence, and the second degree of influence; and multiplying the measurement value of the target component by the correction coefficient.

According to the data processing method described in Clause 2, the degrees of influence of the reference components on the target component are calculated based on the feature amount of the target component and the feature amounts of the reference components. The correction coefficient of the target component is calculated in accordance with the magnitude of the degrees of influence of the reference components. Therefore, the user can correct the measurement value of the target component in accordance with the degrees of influence of the reference components on the target component.

(Clause 3) In the data processing method described in Clause 1 or 2, the second analysis condition may be the same as the first analysis condition.

According to the data processing method described in Clause 3, the measurement value of the target component of the target sample is corrected based on the analysis data of the target sample and the standard sample obtained under the same analysis condition.

(Clause 4) In the data processing method described in any one of Clauses 1 to 3, each of the feature amount of the target component, the feature amount of the first reference component and the feature amount of the second reference component may include at least one of a retention time of a corresponding one of the components, a mass-to-charge ratio of the corresponding one of the components, and a mass-to-charge ratio of a product ion of the corresponding one of the components.

According to the data processing method described in Clause 4, the measurement value of the target component is corrected by using at least one of the retention times of the reference components and the target component, the mass-to-charge ratios of the reference components and the target component, and the mass-to-charge ratios of the product ions of the reference components and the target component.

(Clause 5) In the data processing method described in any one of Clauses 1 to 4, each of the measurement value of the target component, the measurement value of the first reference component and the measurement value of the second reference component may be calculated based on at least one of a peak area and a peak intensity in a chromatogram of a corresponding one of the components.

According to the data processing method described in Clause 5, each of the measurement values of the components is calculated based on at least one of the peak area and the peak intensity in the chromatogram.

(Clause 6) In the data processing method described in Clause 2, each of the calculating the first degree of influence and the calculating the second degree of influence may include determining a corresponding one of the degrees of influence by using at least one of a multidimensional Gaussian distribution function and a multidimensional Cauchy distribution function.

According to the data processing method described in Clause 6, each of the degrees of influence of the reference components is determined by using at least one of the multidimensional Gaussian distribution function and the multidimensional Cauchy distribution function.

(Clause 7) In the data processing method described in Clause 2, in each of the calculating the first degree of influence and the calculating the second degree of influence, a corresponding one of the degrees of influence may become greater as a difference between the feature amount of the target component and the feature amount of a corresponding one of the reference components becomes smaller.

According to the data processing method described in Clause 7, as the difference between the value of the feature amount of the target component and the value of the feature amount of the reference component becomes smaller, a greater weight is assigned to the measurement value of the reference component.

(Clause 8) In the data processing method described in Clause 2, each of the calculating the first degree of influence and the calculating the second degree of influence may include calculating a corresponding one of the degrees of influence in accordance with Equation (3) below:

$$exp ( - 1 * ( \frac{{( {RT}_{Q} - {RT}_{T} )}^{2}}{{σ}_{RT}^{2}} + \frac{{( mz {1}_{Q} - mz {1}_{T} )}^{2}}{{σ}_{mz 1}^{2}} + \frac{{( mz {2}_{Q} - mz {2}_{T} )}^{2}}{{σ}_{mz 2}^{2}} ) ) + C , \qquad ( 3 )$$

where RT_{T} represents a retention time of the target component, RT_{Q} represents a retention time of a corresponding one of the reference components, mz1_{T} represents a mass-to-charge ratio of the target component, mz1_{Q} represents a mass-to-charge ratio of the corresponding one of the reference components, mz2_{T} represents a mass-to-charge ratio of a product ion of the target component, mz2_{Q} represents a mass-to-charge ratio of a product ion of the corresponding one of the reference components, and σ_{RT}, σ_{mz1}, σ_{mz2}, and C are prescribed numbers.

(Clause 9) In the data processing method described in Clause 2, each of the calculating the first degree of influence and the calculating the second degree of influence may include calculating a corresponding one of the degrees of influence in accordance with Equation (4) below:

$$\frac{1}{1 + ( \frac{{( {RT}_{Q} - {RT}_{T} )}^{2}}{{σ}_{RT}^{2}} + \frac{{( mz {1}_{Q} - mz {1}_{T} )}^{2}}{{σ}_{mz 1}^{2}} + \frac{{( mz {2}_{Q} - mz {2}_{T} )}^{2}}{{σ}_{mz 2}^{2}} )} + C , \qquad ( 4 )$$

where RT_{T} represents a retention time of the target component, RT_{Q} represents a retention time of a corresponding one of the reference components, mz1_{T} represents a mass-to-charge ratio of the target component, mz1_{Q} represents a mass-to-charge ratio of the corresponding one of the reference components, mz2_{T} represents a mass-to-charge ratio of a product ion of the target component, mz2_{Q} represents a mass-to-charge ratio of a product ion of the corresponding one of the reference components, and σ_{RT}, σ_{mz1}, σ_{mz2}, and C are prescribed numbers.

(Clause 10) An information processing device according to an aspect includes: at least one or more processors; and a memory that can be accessed by the one or more processors, the memory storing one or more instructions executed by the processors, wherein the processors, by executing the one or more instructions, may obtain a feature amount of a target component included in a target sample and a measurement value of the target component from a first chromatogram, the first chromatogram being obtained by analyzing the target sample at a first timing under a first analysis condition, obtain a feature amount of a first reference component included in a standard sample, a feature amount of a second reference component included in the standard sample, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition, and correct the measurement value of the target component based on the feature amount of the target component, the feature amount of the first reference component, the feature amount of the second reference component, the measurement value of the first reference component at each timing, and the measurement value of the second reference component at each timing, and about the target component, the first reference component and the second reference component, a measurement value of each component may be a value related to an amount of the corresponding component, and a feature amount of each component may be a retention time and/or a mass-to-charge ratio of the corresponding component.

According to the information processing device described in Clause 10, the measurement value of the target component in the target sample can be corrected by using the result obtained by analyzing the standard sample that does not include the target component.

(Clause 11) A mass spectrometer according to an aspect may include: a chromatograph unit that separates, over time, a target component included in a target sample and a first reference component and a second reference component included in a standard sample; a mass spectrometry unit that measures an ion having a mass-to-charge ratio derived from the target component, the first reference component and the second reference component separated by the chromatograph unit; and a control unit that controls operations of the chromatograph unit and the mass spectrometry unit, wherein the control unit may be configured to obtain a feature amount of the target component and a measurement value of the target component from a first chromatogram, the first chromatogram being obtained by analyzing the target sample at a first timing under a first analysis condition, obtain a feature amount of the first reference component, a feature amount of the second reference component, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition, and correct the measurement value of the target component based on the feature amount of the target component, the feature amount of the first reference component, the feature amount of the second reference component, the measurement value of the first reference component at each timing, and the measurement value of the second reference component at each timing, and about the target component, the first reference component and the second reference component, a measurement value of each component may be a value related to an amount of the corresponding component, and a feature amount of each component may be a retention time and/or a mass-to-charge ratio of the corresponding component.

According to the mass spectrometer described in Clause 11, the measurement value of the target component in the target sample can be corrected by using the result obtained by analyzing the standard sample that does not include the target component.

(Clause 12) A program according to an aspect is a program executed by a processor mounted on a computer, wherein the computer may obtain a feature amount of a target component included in a target sample and a measurement value of the target component from a first chromatogram, the first chromatogram being obtained by analyzing the target sample at a first timing under a first analysis condition, obtain a feature amount of a first reference component included in a standard sample, a feature amount of a second reference component included in the standard sample, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition, and correct the measurement value of the target component based on the feature amount of the target component, the feature amount of the first reference component, the feature amount of the second reference component, the measurement value of the first reference component at each timing, and the measurement value of the second reference component at each timing, and about the target component, the first reference component and the second reference component, a measurement value of each component may be a value related to an amount of the corresponding component, and a feature amount of each component may be a retention time and/or a mass-to-charge ratio of the corresponding component.

According to the program described in Clause 12, the measurement value of the target component in the target sample can be corrected by using the result obtained by analyzing the standard sample that does not include the target component.

Although the embodiment of the present disclosure has been described, it should be understood that the embodiment disclosed herein is illustrative and non-restrictive in every respect. The scope of the present disclosure is defined by the terms of the claims, and is intended to include any modifications within the scope and meaning equivalent to the terms of the claims.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding Japanese application No. 2024-069261, filed Apr. 22, 2024, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. A data processing method of correcting a measurement value of a target component in a target sample by using a standard sample including a first reference component and a second reference component, the measurement value of the target component being obtained by an analysis device including a mass spectrometer or a chromatograph mass spectrometer,
about the target component, the first reference component and the second reference component,
a measurement value of each component being a value related to an amount of the corresponding component, and
a feature amount of each component being a retention time and/or a mass-to-charge ratio of the corresponding component,
the data processing method comprising:
obtaining a feature amount of the target component and the measurement value of the target component from a first chromatogram, the first chromatogram being obtained by analyzing the target sample at a first timing under a first analysis condition;
obtaining a feature amount of the first reference component, a feature amount of the second reference component, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition; and
correcting the measurement value of the target component based on the feature amount of the target component, the feature amount of the first reference component, the feature amount of the second reference component, the measurement value of the first reference component at each timing, and the measurement value of the second reference component at each timing.

2. The data processing method according to claim 1, wherein
the correcting includes:
calculating a first degree of influence by using the feature amount of the target component and the feature amount of the first reference component, the first degree of influence being a degree of influence of the first reference component;
calculating a second degree of influence by using the feature amount of the target component and the feature amount of the second reference component, the second degree of influence being a degree of influence of the second reference component;
calculating a correction coefficient of the target component based on the measurement value of the first reference component at each timing, the measurement value of the second reference component at each timing, the first degree of influence, and the second degree of influence; and
multiplying the measurement value of the target component by the correction coefficient.

3. The data processing method according to claim 1, wherein
the second analysis condition is the same as the first analysis condition.

4. The data processing method according to claim 1, wherein
each of the feature amount of the target component, the feature amount of the first reference component and the feature amount of the second reference component includes at least one of a retention time of a corresponding one of the components, a mass-to-charge ratio of the corresponding one of the components, and a mass-to-charge ratio of a product ion of the corresponding one of the components.

5. The data processing method according to claim 1, wherein
each of the measurement value of the target component, the measurement value of the first reference component and the measurement value of the second reference component is calculated based on at least one of a peak area and a peak intensity in a chromatogram of a corresponding one of the components.

6. The data processing method according to claim 2, wherein
each of the calculating the first degree of influence and the calculating the second degree of influence includes determining a corresponding one of the degrees of influence by using at least one of a multidimensional Gaussian distribution function and a multidimensional Cauchy distribution function.

7. The data processing method according to claim 2, wherein
in each of the calculating the first degree of influence and the calculating the second degree of influence, a corresponding one of the degrees of influence becomes greater as a difference between the feature amount of the target component and the feature amount of a corresponding one of the reference components becomes smaller.

8. The data processing method according to claim 2, wherein
each of the calculating the first degree of influence and the calculating the second degree of influence includes calculating a corresponding one of the degrees of influence in accordance with Equation (1) below:
$$exp ( - 1 * ( \frac{{( {RT}_{Q} - {RT}_{T} )}^{2}}{{σ}_{RT}^{2}} + \frac{{( mz {1}_{Q} - mz {1}_{T} )}^{2}}{{σ}_{mz 1}^{2}} + \frac{{( mz {2}_{Q} - mz {2}_{T} )}^{2}}{{σ}_{mz 2}^{2}} ) ) + C , \qquad ( 1 )$$
where RT_{T} represents a retention time of the target component, RT_{Q} represents a retention time of a corresponding one of the reference components, mz1_{T} represents a mass-to-charge ratio of the target component, mz1_{Q} represents a mass-to-charge ratio of the corresponding one of the reference components, mz2_{T} represents a mass-to-charge ratio of a product ion of the target component, mz2_{Q} represents a mass-to-charge ratio of a product ion of the corresponding one of the reference components, and σ_{RT}, σ_{mz1}, σ_{mz2}, and C are prescribed numbers.

9. The data processing method according to claim 2, wherein
each of the calculating the first degree of influence and the calculating the second degree of influence includes calculating a corresponding one of the degrees of influence in accordance with Equation (2) below:
$$\frac{1}{1 + ( \frac{{( {RT}_{Q} - {RT}_{T} )}^{2}}{{σ}_{RT}^{2}} + \frac{{( mz {1}_{Q} - mz {1}_{T} )}^{2}}{{σ}_{mz 1}^{2}} + \frac{{( mz {2}_{Q} - mz {2}_{T} )}^{2}}{{σ}_{mz 2}^{2}} )} + C , \qquad ( 2 )$$
where RT_{T} represents a retention time of the target component, RT_{Q} represents a retention time of a corresponding one of the reference components, mz1_{T} represents a mass-to-charge ratio of the target component, mz1_{Q} represents a mass-to-charge ratio of the corresponding one of the reference components, mz2_{T} represents a mass-to-charge ratio of a product ion of the target component, mz2_{Q} represents a mass-to-charge ratio of a product ion of the corresponding one of the reference components, and σ_{RT}, σ_{mz1}, σ_{mz2}, and C are prescribed numbers.

10. A chromatograph mass spectrometer comprising:
a chromatograph unit that separates, over time, a target component included in a target sample and a first reference component and a second reference component included in a standard sample;
a mass spectrometry unit that measures a mass-to-charge ratio of an ion derived from the target component, the first reference component and the second reference component separated by the chromatograph unit; and
a control unit that controls operations of the chromatograph unit and the mass spectrometry unit, wherein
the control unit is configured to
obtain a feature amount of the target component and a measurement value of the target component from a first chromatogram, the first chromatogram being obtained by analyzing the target sample at a first timing under a first analysis condition,
obtain a feature amount of the first reference component, a feature amount of the second reference component, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition, and
correct the measurement value of the target component based on the feature amount of the target component, the feature amount of the first reference component, the feature amount of the second reference component, the measurement value of the first reference component at each timing, and the measurement value of the second reference component at each timing, and
about the target component, the first reference component and the second reference component,
a measurement value of each component is a value related to an amount of the corresponding component, and
a feature amount of each component is a retention time and/or a mass-to-charge ratio of the corresponding component.

11. A computer readable medium having a program stored thereon in a non-transitory manner, the program being executed by a processor mounted on a computer, wherein the program, by being executed by the processor, causes the computer to perform:
obtaining a feature amount of a target component included in a target sample and a measurement value of the target component from a first chromatogram, the first chromatogram being obtained by analyzing the target sample at a first timing under a first analysis condition;
obtaining a feature amount of a first reference component included in a standard sample, a feature amount of a second reference component included in the standard sample, a measurement value of the first reference component at each timing, and a measurement value of the second reference component at each timing from a second chromatogram and a third chromatogram, the second chromatogram being obtained by analyzing the standard sample at a second timing under the first analysis condition, the third chromatogram being obtained by analyzing the standard sample at a third timing under a second analysis condition; and
correcting the measurement value of the target component based on the feature amount of the target component, the feature amount of the first reference component, the feature amount of the second reference component, the measurement value of the first reference component at each timing, and the measurement value of the second reference component at each timing, and
about the target component, the first reference component and the second reference component,
a measurement value of each component is a value related to an amount of the corresponding component, and
a feature amount of each component is a retention time and/or a mass-to-charge ratio of the corresponding component.
